(19) United States
(12) Patent Application Publication
(10) Pub. No.: US 2014/0183199 A1
(43) Pub. Date: Jul. 3, 2014

(54) Combined Saucepan and Brush Holder

(71) Applicant: Joseph Charles Thompson, Dallas County, TX (US)

(72) Inventor: Joseph Charles Thompson, Dallas County, TX (US)

(21) Appl. No.: 13/732,930

(22) Filed: Jan. 2, 2013

(51) Int. Cl. A47J 27/00

(52) U.S. Cl. CPC A47J 27/002
USPC 220/573.1

(57) ABSTRACT

A saucepan has a substantially flat bottom and an open top. A combined handle and two legs are attached to the side of the pan, and a basting brush support affixed to the top of the handle. The handle and the two legs are of wire construction. The legs are beneath the handle, one leg being part of each end of the handle. The handle is mostly horizontal so that the handle of a basting brush can easily rest on the handle along with the basting brush support. The support member is designed to receive the handle of a basting brush when handle of the basting brush is lying on the support member. The brush is oriented so that the bristles of the brush are over the open top of the pan. In this way, sauce from the basting brush drips into the pan.

### CROSS-REFERENCE TO RELATED APPLICATIONS

### Statement Regarding Federally Sponsored Research or Development

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to saucepans and basting brushes.

2. Description of Related Art

Saucepans and basting brushes have been around for a long time. The question of what to do with the basting brush when it is not in use has also been around a long time. Normally, the brush is put onto a saucer or plate when not in use, generally making a mess.

### BRIEF SUMMARY OF THE INVENTION

A saucepan and brush holder includes a pan having a substantially flat bottom and an open top, a combined handle and two legs attached to the side of the pan, and a basting brush support affixed to the top of the handle. The handle and the two legs are of wire construction, the handle forming a loop on the distal end from the pan. The legs are beneath the handle, one leg being part of each end of the handle. The handle is mostly horizontal so that the handle of a basting brush can easily rest on the handle along with the basting brush support. The bottom of the legs touch any support surface for the pan and are substantially even with the bottom of the pan so that the weight of the brush does not tip over the pan. The support member is designed to receive the handle of a basting brush when the basting brush is lying on the support member. The brush is oriented so that the bristles of the brush are over the open top of the pan. In this way, sauce from the basting brush drips into the pan.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a side elevation view of a saucepan, brush holder and brush according to the present invention; and

FIG. 2 is a top view of the saucepan, brush holder and brush of FIG. 1.

### DETAILED DESCRIPTION OF THE INVENTION

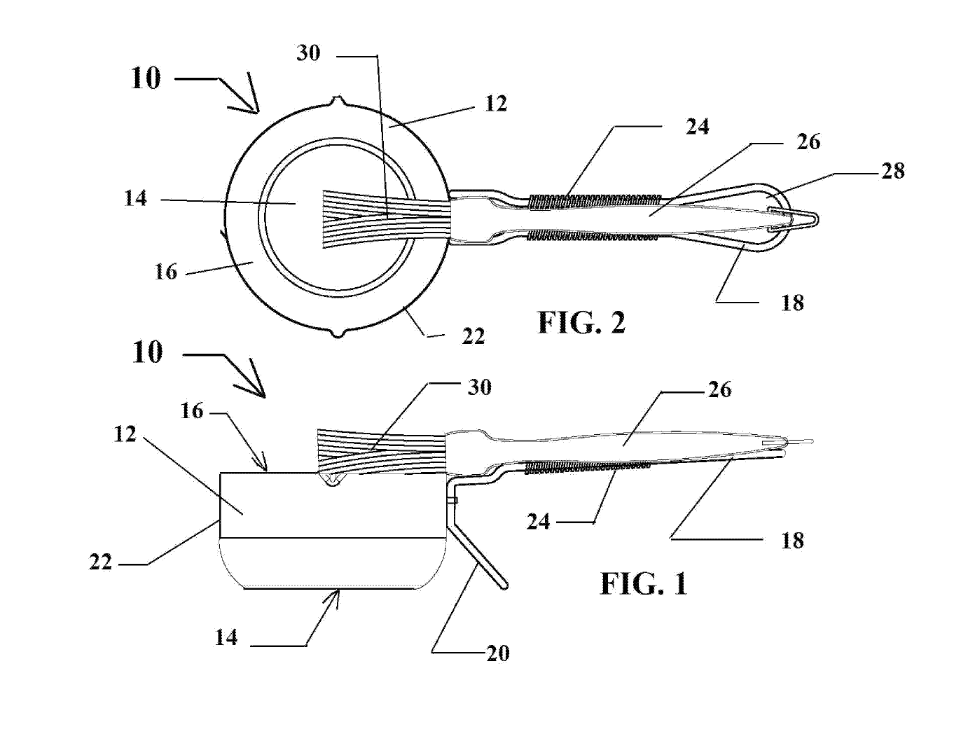

Referring now to the drawing, and in particular to FIG. 1 and FIG. 2, a saucepan, brush holder and brush according to the present invention is referred to generally by reference numeral 10. Combined saucepan, brush holder and brush includes a pan 12 having a substantially flat bottom 14 and an open top 16. A combined handle 18 and two legs 20 are attached to the side 22 of pan 12. Only one of the two legs 20 is visible in the figures, since the other leg 20 is hidden behind the forward leg. A support 24 for a basting brush 26 is affixed to the top of handle 18. The handle and the two legs are of wire construction, the handle forming a loop 28 on the distal end from pan 12. The legs are beneath the handle, one leg being part of each end of the handle. The handle is mostly horizontal so that the handle of a basting brush can easily rest on the handle along with the basting brush support. The bottom of the legs touch any surface on which the pan is resting and are substantially even with the bottom of the pan so that the weight of the brush does not tip over the pan. The support member is designed to receive the handle of a basting brush when the basting brush is lying on the support member. The brush is oriented so that the bristles 30 of the brush are over the open top 16 of pan 12. In this way, sauce from the basting brush bristles drips into the pan.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A saucepan and brush holder comprising, in combination:
a pan for holding sauce for brushing on food items as they are cooking having a substantially flat bottom and an open top;
a mostly horizontal handle attached to the side of the pan;
at least one leg attached to the side of the pan beneath the handle, wherein the bottom of the at least one leg touches any support surface for the pan and is substantially even with the bottom of the pan, and wherein the handle of the pan is designed to support the handle of a basting brush lying on the handle of the pan with the bristles of the brush over the open top of the pan.

2. A saucepan and brush holder comprising, in combination:
a pan for holding sauce for brushing on food items as they are cooking having a substantially flat bottom and an open top;
a combined, unitary handle and at least one leg attached to the side of the pan,
wherein the at least one leg combined and unitary with the handle is beneath the handle and the handle is mostly horizontal, and wherein the bottom of the at least one leg touches any support surface for the pan and is substantially even with the bottom of the pan; and
a basting brush support member affixed to the top of the handle, wherein the support member is designed to receive the handle of a basting brush lying on the support member with the bristles of the brush over the open top of the pan.

3. A saucepan and brush holder according to claim 2, wherein the combined, unitary handle and leg are of wire construction.

4. A saucepan and brush holder comprising, in combination:
a pan for holding sauce for brushing on food items as they are cooking having a substantially flat bottom and an open top;
a combined, unitary handle and two legs attached to the side of the pan, wherein the combined, unitary handle and two legs are of wire construction, wherein the handle forms a loop on the distal end from the pan and the legs are beneath the handle, one leg being part of each end of the handle opposite the loop and the handle is mostly horizontal, and wherein the bottom of the legs touch any support surface for the pan and are substantially even with the bottom of the pan; and
a basting brush support member affixed to the top of the handle, wherein the support member is designed to receive the handle of a basting brush lying on the support member with the bristles of the brush over the open top of the pan.

5. A saucepan and brush holder comprising, in combination:
a pan for holding sauce for brushing on food items as they are cooking having a substantially flat bottom and an open top;
a combined, unitary handle and two legs attached to the side of the pan, wherein combined, unitary handle and two legs are of wire construction, wherein the handle forms a loop on the distal end from the pan and two sides and the legs are beneath the handle, one leg being part of each end of the handle opposite the loop and the handle is mostly horizontal, and wherein the bottom of the legs touch any support surface for the pan and are substantially even with the bottom of the pan;
a basting brush having an elongated handle and bristles affixed to one end of the elongated handle; and
a basting brush support member affixed to the top of the handle and spanning the distance between the two sides of the handle, wherein the support member is designed to receive the handle of the basting brush, lying on the support member with the bristles of the brush over the open top of the pan.
